(19) United States
(12) Patent Application Publication
(10) Pub. No.: US 2001/0053815 A1
(43) Pub. Date: Dec. 20, 2001

(54) Polyurethane dispersions and films produced therewith

(76) Inventors: Debkumar Bhattacharjee, Lake Jackson, TX (US); William A. Koonce, Pearland, TX (US); Franklin E. Parks, Jones Creek, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/824,652

(22) Filed: Apr. 3, 2001

Related U.S. Application Data
(60) Provisional application No. 60/204,874, filed on May 16, 2000.

(51) Int. Cl. C08K 3/00

(52) U.S. Cl. 524/839

(57) ABSTRACT

Aqueous polyurethane dispersions and films prepared therefrom are prepared from a nonionic polyurethane prepolymer and water. The nonionic polyurethane prepolymer is prepared from a diisocyanate and a low monol polyether polyol. Such dispersions and films have applicability in gloves, condoms, angioplasy balloons and the like.

### CROSS-REFERENCE TO PRIOR APPLICATION

This application claims the benefit of U.S. Provisional Application No. 60/204,874 filed May 16, 2000.

### BACKGROUND OF THE INVENTION

This invention relates to film prepared from aqueous polyurethane dispersions. This invention particularly relates to aqueous polyurethane dispersions useful for preparing gloves.

While ostensibly reactive with water, it has long been known that polyisocyanate polymers can be used to prepare aqueous polyurethane dispersions. Polyurethane dispersions are generally prepared by chain extending the reaction product of an organic diisocyanate or polyisocyanate and an organic compound having two or more active hydrogen atoms such as polyalkylene ether glycols, poly(alkylene ether-alkylene thioether) glycols, alkyd resins, polyesters and polyester amides, often using an organic solvent. The diisocyanate is used in stoichiometric excess so that the reaction product, also referred to as a polyurethane/urea/thiourea prepolymer, is isocyanate terminated. Examples of polyurethane prepolymer preparations are described in U.S. Pat. Nos. 3,178,310; 3,919,173; 4,442,259; 4,444,976; and 4,742,095; among others.

Polyurethane dispersions are reported as being useful for preparing such diverse materials as: coatings and bonds in U.S. Pat. No. 4,292,226; flexible solvent barriers in U.S. Pat. No. 4,431,763; adhesives in U.S. Pat. No. 4,433,095; and films in U.S. Pat. No. 4,501,852. Films, or rather the process of dipping to make a film, can be a part of the processes for making many articles. Examples of film applications include exam gloves, organ bags, condoms, ostomy bags, and the like. While it is known that such applications can be made with polyurethane dispersions, conventional polyurethane dispersions have sometimes been found to have insufficient physical or handling properties to make them a preferred material for such applications. Also, the use of a solvent can have adverse effects for some applications.

Polyurethanes are the reaction product of a polyalcohol and a polyisocyanate. Typically, the polyisocyanates used to prepare polyurethane dispersions have been aliphatic isocyanates such are disclosed in U.S. Pat. No. 5,494,960. Aromatic polyisocyanates such as toluene diisocyanate (TDI) and methylene diphenyldiisocyanate (MDI) as well as polymethylene polyphenylisocyanate are also known to be useful.

Conventional processes of preparing films from dispersions, including polyurethane dispersions, generally include a step of coagulating the latex onto a substrate. It is therefore necessary that latexes used to make films have the property that they can be coagulated onto a substrate. At the same time, it is considered desirable in the art of making latex dispersions that the dispersions be stable, that is that they do not settle or spontaneously coagulate during shipping on storage. Accordingly, it would be desirable in the art of preparing aqueous dispersions useful for preparing films that the dispersions be capable of being coagulated onto a substrate using conventional coagulants and coagulation technology.

Films prepared from natural rubber latex are considered to have properties which are desirable from the perspective of comfort and utility. Unfortunately, natural rubber latex also includes proteins and other materials which can be irritating to skin.

It would be desirable in the art of preparing films to prepare a water-based film which has physical properties similar to natural rubber latex films but which doesn't include the dermal irritants which occur in natural rubber latex.

### SUMMARY OF THE INVENTION

In one aspect, the present invention is a polyurethane film comprising a film prepared from an aqueous polyurethane dispersion, the dispersion being prepared from a nonionic polyurethane prepolymer and water, wherein the nonionic polyurethane prepolymer is prepared from a polyisocyanate and a low monol polyether polyol.

In another aspect, the present invention is a process for preparing an aqueous polyurethane dispersion comprising preparing a nonionic polyurethane prepolymer from a polyisocyanate and a low monol polyol; and admixing the nonionic polyurethane prepolymer with water.

In another aspect, the present inventions is a polyurethane dispersion prepared by preparing a nonionic polyurethane prepolymer from a polyisocyanate and a low monol polyol; and admixing the nonionic polyurethane prepolymer with water.

By utilizing a high molecular weight, low unsaturated polyol, the present invention has the advantage of being an economical, water-based polyurethane dispersion which has the desirable properties of natural latex rubber but does not include the dermal irritants which occur in natural rubber latex. The present invention can be used to prepare, for example, dipped rubber goods, such as gloves, condoms, catheters, and angioplasty balloons.

### DESCRIPTION OF THE PREFERRED EMBODIMENTS

The polyurethane prepolymer dispersions of the present invention are prepared by dispersing a nonionic polyurethane prepolymer in water using one or more external surfactants. The resulting polyurethane dispersion is useful for preparing films. For purposes of the present invention, the phrase “useful for preparing films” means that while the dispersions are sufficiently stable to be stored, they are not so stable that they cannot be electrodeposited or coagulated onto a substrate to make a film or other latex derived product.

The dispersions of the present invention can be prepared in any way which results in a dispersion which can be used to prepare a film having acceptable physical properties for the anticipated use of the film. The dispersions can be prepared by a batch process or by a continuous process. If prepared by a batch process, preferably the dispersion is prepared by an inverse phase process wherein a small amount of water, including a small amount of anionic surfactant, is first added to a continuous prepolymer phase and mixed and then more water is added with mixing until the phase inverts.

When dispersions of the process of the present invention are prepared by means of a continuous process, preferably they are prepared by means of a high internal phase ratio (HIPR) process. Such processes are known and are disclosed in, for Example, U.S. Pat. No. 5,539,021 to Pate et al., and U.S. Pat. No. 5,959,027 to Jakubowski et al. Other continuous dispersion processes can be used with the process of the present invention with the proviso that they result in a stable dispersion or at least a dispersion which is sufficiently dispersed to be further processed in the second step and result in a stable dispersion. For purposes of the present invention, a dispersion is stable if it does not settle, or separate out too quickly to be useful for its intended purpose.

When preparing the polyurethane dispersions of the present invention using more than one surfactant, the two surfactants can be added in two separate steps. In the first step, the first surfactant can be used to aid in dispersing the prepolymer. In the second step of the process of the present invention, the dispersion from the first step is admixed with a different external surfactant and admixed. The admixture of the second step may be prepared by any method which results in a stable polyurethane dispersion. The product of the second step of the process of the present invention, irrespective of admixing methods used, should have a particle size sufficient to make the dispersion stable. The dispersions of the present invention will have a particle size of from 0.9 to about 0.05, preferably from about 0.5 to about 0.07 and even more preferably, from about 0.4 to 0.10 microns. Most preferably, the particle size of the dispersions of the present invention is about 0.15 microns.

The polyurethane dispersions of the present invention are prepared from a nonionic polyurethane prepolymer. The nonionic prepolymers useful with the present invention are prepared with an aliphatic or aromatic diisocyanate. Preferably, the diisocyanate is an aromatic diisocyanate selected from the group consisting of MDI, TDI and mixtures thereof. TDI can be generally used with any commonly available isomer distribution. The most commonly available TDI has an isomer distribution of 80 percent of the 2,4 isomer and 20 percent of the 2,6 isomer. For the purposes of the present invention, TDI with other isomer distributions can also be used, but often at significantly higher cost.

When MDI is used with the formulations of the present invention, it preferably has a P,P′ isomer content of from about 99 percent to about 90 percent. Even more preferably, when MDI is used with the formulations of the present invention, it preferably has a P,P′ isomer content of from about 98 to about 92 percent. Most preferably, when MDI is used with the formulations of the present invention, it preferably has a P,P′ isomer content of about 94 percent. While MDI with such isomer distributions can be prepared by distillation during the MDI process, it can also be prepared by admixing commonly available products such as ISONATE 125M* and ISONATE 500P*. (*ISONATE 125M and ISONATE 500P are trade designations of The Dow Chemical Company.)

When mixtures of TDI and MDI are used to prepare the prepolymers useful with the present invention, they are admixed in a ratio of MDI to TDI of from about 99 percent MDI to about 80 percent MDI. More preferably, when mixtures of TDI and MDI are used to prepare prepolymers useful with the present invention, they are admixed in a ratio of MDI to TDI of from about 98 percent MDI to about 90 percent MDI. Most preferably, when mixtures of TDI and MDI are used to prepare the prepolymers useful with the present invention, they are admixed in a ratio of MDI to TDI of about 96 percent MDI. Preferably, the prepolymers useful with the present invention are prepared with MDI or mixtures of MDI and TDI. Even more preferably, the prepolymers useful with the present invention are prepared with MDI as the only aromatic diisocyanate.

In one embodiment of the present invention, the prepolymers useful with the present invention are prepared from a formulation that includes an active hydrogen containing material. In a preferred embodiment of the present invention, the active hydrogen containing material is a mixture of diols. One component of the preferred diol mixture is a high molecular weight polyether or polyester diol, for example a high molecular weight polyoxypropylene diol, optionally having an ethylene oxide capping of from 0 to 25 weight percent. The other component of the diol mixture is a low molecular weight diol.

Generally, the polyether diols of the formulations of the present invention can be prepared by any method known to those of ordinary skill in the art of preparing polyether polyols to be useful for preparing such diols.

The high molecular weight polyether diol component of the diol mixture of the prepolymer formulations of the present invention is a polyoxypropylene diol having an ethylene oxide capping of from 0 to 25 weight percent. Preferably, the molecular weight of this component is from about 1000 to about 10,000, more preferably from about 1500 to about 8000 and most preferably from about 2000 to about 6000. As stated, the polyether diol is optionally capped with from 0 to 25 percent ethylene oxide. In the alternative, a combination of polyethers having an average ethylene oxide capping of from 0 to 25 percent can also be used. Preferably, the high molecular weight diol is capped with from about 5 to about 25 percent ethylene oxide, and more preferably, from about 10 to about 15 percent ethylene oxide.

In the practice of the present invention, the high molecular weight polyether diol component of the diol mixture of the prepolymer formulations of the present invention is a low or ultra-low monol containing polyol. In the practice of preparing polyols using propylene oxide, occasionally rather than anionic polymerization of propylene oxide, an undesirable side reaction occurs resulting in a monol terminated with a double bond. These reactions are very common in alkali metal hydroxide catalyzed polyol processes. As the average molecular weight of a polyoxypropylene polyol increases during alkali metal hydroxide catalyzed synthesis, the concentration of monol increases until it reaches ranges of, for example, from 20 to 40 mole percent of monol for a 4000 molecular weight polyoxypropylene polyol. Generally, the level of unsaturation increases as the molecular weight of the polyol increases.

Low monol polyols are those with measured unsaturations, measured according to ASTM Designation D-4671-87, of less than about 0.025 meq/g, preferably less than about 0.020 meq/g, more preferably less than about 0.015 meq/g, even more preferably less than about 0.010 meq/g, and most preferably less than about 0.005 meq/g. The range of 0.001 to 0.005 meq/g is sometimes also referred to as ultra-low monol polyols. Such polyoxypropylene polyols may be prepared by any way known to be useful to one skilled in the art of preparing polyols. Because the low monol polyols have a relatively high molecular weight and a relatively low unsaturation, such low monol polyols are sometimes referred to as high molecular weight, low unsaturation polyols.

Polyols useful with the process of the present invention can be prepared using an alkali metal hydroxide catalyst followed by post treatment to hydrolyze the unsaturation. Another method of preparing such polyols is by use of the so called double metal cyanide catalysts. Hybrid processes can also be used. The actual method of catalysis is not important; the critical feature is the low unsaturation of less than 0.025 meq/g. The equivalent and molecular weights expressed herein are in Da (Daltons) and are number average equivalent and molecular weights. The low monol polyols should comprise a major portion, i.e. greater than 50 weight percent, preferably greater than 80 weight percent, of the polyol blend used to prepare the isocyanate-terminated prepolymer, and substantially all of the total polyether polyol portion of the polyol component should be a low unsaturation polyol such that the total polyol component unsaturation is less than 0.025 meq/g.

The low molecular weight diol component of some of the prepolymer formulations of the present invention can also be a product of alkoxylating a difunctional initiator. Preferably, this component is also a polyoxypropylene diol, but it can also be a mixed ethylene oxide propylene oxide polyol, as long as at least 75 weight percent of the alkoxides used, if present, is propylene oxide. Diols such as propylene glycol, diethylene glycol, dipropylene glycol, 1,4-butane diol, and the like, can also be used with the formulations of the present invention. The low molecular weight diol component of the prepolymer formulations, if present, has a molecular weight of from about 60 to about 750, preferably from about 62 to about 600, and most preferably, from about 125 to about 500. Typically, low molecular weight polyols are low monol polyols, but this low molecular weight polyol component can be a low monol polyol, a convention polyol or mixtures thereof.

The prepolymers useful with the present invention can be prepared in any way known to those of ordinary skill in the art of preparing polyurethane prepolymers. Preferably the diisocyanate and polyether diol mixture are brought together and heated under reaction conditions sufficient to prepare a polyurethane prepolymer. The stoichiometry of the prepolymer formulations of the present invention is such that the diisocyanate is present in excess. Preferably, the prepolymers useful with the present invention have an isocyanate content (also known as %NCO) of from about 1 to about 9 weight percent, more preferably from about 2 to about 8 weight percent, and most preferably from about 3 to about 7 weight percent.

The prepolymers useful with the present invention are optionally extended, sometimes using a difunctional amine chain extender when the active hydrogen containing material of the prepolymer formulation is a mixture of a low molecular weight diol and a high molecular weight polyether diol. The difunctional amine chain extender may not be optional, but rather be required when the active hydrogen containing material of the prepolymer formulation is a high molecular weight polyether diol and does not include a low molecular weight diol. Preferably, the difunctional amine chain extender, if present, is present in the water used to make the dispersion. When used, the amine chain extender can be any isocyanate reactive diamine or amine having another isocyanate reactive group and a molecular weight of from about 60 to about 450, but is preferably selected from the group consisting of: an aminated polyether diol; piperazine, aminoethylethanolamine, ethanolamine, ethylenediamine and mixtures thereof. The prepolymers are preferably chain extended to the point where no covalent cross-linking occurs, such that the resulting prepolymer has an average practical functionality of less than about 2.1. Preferably, the amine chain extender is dissolved in the water used to make the dispersion such that amine chain extension is carried out after the prepolymer has been initially emulsified in the water.

The prepolymers useful with the present invention are nonionic. That is, there are no ionic groups incorporated in or attached to the backbones of the prepolymers used to prepare the films of the present invention. The anionic surfactant used to prepare the dispersions of the present invention is a external stabilizer and is not incorporated into the polymer backbones of the films of the present invention.

The prepolymers useful with the present invention are dispersed in water which contains a surfactant. Preferably the surfactant is an anionic surfactant. In the practice of preparing the dispersions of the present invention, the surfactant is preferably introduced into water prior to a prepolymer being dispersed therein, but it is not outside the scope of the present invention that the surfactant and prepolymer could be introduced into the water at the same time. Any anionic surfactant can be used with the present invention, but preferably the anionic surfactant is selected from the group consisting of sulfonates, phosphates, and carboxylates. More preferably the anionic surfactant is sodium dodecyl benzene sulfonate, sodium dodecyl sulfonate, sodium dodecyl diphenyl oxide disulfonate, sodium n-decyl diphenyl oxide disulfonate, isopropylamine dodecylbenzenesulfonate, or sodium hexyl diphenyl oxide disulfonate.

In the practice of the process of the present invention, in an optional second step, a polyurethane dispersion prepared with a first external surfactant is admixed with a second and different external surfactant. Most preferably, the external surfactant used with the process of the present invention as the second step surfactant is triethanolamine lauryl sulfate. Other external surfactants can also be used in the second step of the process of the present invention and can either be the same surfactant as that used in the first step, or a different surfactant.

The dispersions of the present invention can have a solids level of from about 30 weight percent to about 60 weight percent. Films will not necessarily be prepared from dispersions having this level of solids. While the dispersions themselves will be stored and shipped at as high a solids content as possible to minimize storage volume and shipping costs, the dispersions can desirably be diluted prior to final use. The thickness of the film to be prepared and the method of coagulating the polymer onto a substrate will usually dictate what solids level is needed in the dispersion. When preparing films, the dispersions of the present invention can be at a weight percent solids of from 5 to about 60 percent, preferably from about 10 to about 40 percent, and, most preferably, from about 15 to about 25 weight percent when preparing examination gloves. For other applications, the film thickness and corresponding solids content of the dispersion used can vary.

Advantageously, films prepared using dispersion of the present invention can be prepared such that they are self-releasing. In the art of preparing exam gloves, this ability is also known as “powder free” in reference to the fact that such gloves are occasionally prepared and sold with a layer of talcum powder, corn starch, or the like, to keep the polymer from adhering to itself, thereby making it easier to put on the gloves. The films of the present invention can be made self releasing by any method known to those of ordinary skill in preparing gloves to useful for preparing powder free gloves.

Any additive which is known to those of ordinary skill in the art of preparing films from dispersion to be useful can be used with the process of the present invention so long as their presence does not degrade the properties of the dispersions or films prepared therewith so much that the films are no longer fit for their intended purposes. The additives can also be incorporated into the formulations or films in any way known to be useful including, but not limited to inclusion in the prepolymer formulation and inclusion in the water used to make the dispersion. For example titanium dioxide is useful for coloring films of the present invention. Other useful additives include calcium carbonate, silicon oxide, defoamers, biocides, carbon particles, and the like.

The following examples are for illustrative purposes only and are not intended to limit the scope of the claimed invention. Percentages are in weight percents unless otherwise stated.

### EXAMPLES

The following materials are used in the examples below:

Polyether Polyol I is a low monol (unsaturation=0.001 meq/g) 4000 molecular weight polyoxypropylene diol having 12 percent ethylene oxide end capping.

Polyether Polyol II is a low monol (unsaturation=0.005 meq/g) 3750 molecular weight polyoxypropylene diol having 12 percent ethylene oxide end capping.

Low Molecular Weight Diol is a 134 molecular weight all polyoxypropylene diol (dipropyleneglycol).

Polyisocyanate A is MDI having a 4,4′ isomer content of 98 percent and an isocyanate equivalent weight of 125 (ISONATE*125M from The Dow Chemical Company).

Chain extender is a 104 molecular weight diamine (aminoethylethanolamine).

Surfactant is a 22 wt. % solution of sodium dodecylbenzene sulfonate in water.

### Example 1

A polyurethane prepolymer is prepared by admixing 72.0 parts of Polyether Polyol 1, and 4.0 parts Low Molecular Weight Diol and then heating the admixture to 50° C. This material is then admixed with 24.0 parts of Polyisocyanate I which has also been warmed to 50° C. The admixture is then heated at 70° C. for 6 hours and then tested to determine NCO content. The NCO content is 4.0 percent.

A polyurethane dispersion is prepared by admixing 200 g of the prepolymer admixed with 14 g water and 34 g surfactant using a high shear mixer running at about 2500 rpm. 258 g additional water is slowly added until a phase inversion is observed.

A film is then prepared by a coagulation process by heating a steel plate in an oven until it reached a temperature of from 100 to 120° F. (38-49° C.). The plate is then dipped into a 20 percent solution of calcium nitrate in 1:1 by weight of water and methanol which also included about 1 wt % of a ethoxylated octylphenol surfactant. The plate is then placed into an oven at 230° F. (1 10° C.) for approximately 15 minutes to form a very thin film of calcium nitate on the plate. The plate is allowed to cool to 105° F. (40° C.) and then dipped into the polyurethane dispersion diluted to 23% solids with deionized water and removed (total dwell time is approximately 20 sec). The plate is held for 5 minutes at room temperature to allow the film to generate enough gel strength, followed by leaching in a water bath at 115° F. (46° C.) for 10 minutes. Both sides of the plate is then sprayed with water at 115° F. (40° C.) for two additional minutes. The plate is then heated to 230° F. (1 10° C.) for 30 minutes and then cooled to ambient temperature. A polyurethane film is peeled from the substrate and tested using ASTM Designation D 412-98a (Die C; overall length=4.5″, width of narrow section=0.25″, and gauge length=1.31″) Testing results are presented in the table. It is tactilely soft and yet has good physical properties.

### Example 2

A Prepolymer is prepared the same as in Example 1. However, during the dispersion process the diamine is used during final dilution step to replace some of the water extension. The amount of diamine used is calculated to react with 25% of available isocyanate in prepolymer.

### Examples 3

A polyurethane prepolymer is prepared by admixing 71.5 parts of Polyether Polyol I, and 4.0 parts Low Molecular Weight Diol and then heating the admixture to 50° C. This material is then admixed with 24.5 parts of Polyisocyanate I which has also been warmed to 50° C. The admixture is then heated at 70° C. for 6 hours and then tested to determine NCO content. The NCO content is 4.0 percent.

The dispersion and films were made using same procedure as in Example 1.

### Example 4

A prepolymer is prepared the same as in Example 3. However, during the dispersion process the diamine is used during final dilution step to replace some of the water extension. The amount of diamine used is calculated to react with 25% of available isocyanate in prepolymer.

TABLE I

| | EXAMPLE | | | |
|---|---|---|---|---|
| | 1 | 2 | 3 | 4 |
| POLYETHER | 72 | 72 | | |
| POLYOL I | | | | |
| (parts by wt) | | | | |
| POLYETHER | | | 71.5 | 71.5 |
| POLYOL II | | | | |
| (parts by wt) | | | | |
| LOW MWT DIOL | 4 | 4 | 4 | 4 |
| (parts by wt) | | | | |
| POLY- | 24 | 24 | 24.5 | 24.5 |
| ISOCYANATE A | | | | |
| (parts by wt) | | | | |
| % NCO | 4.0 | 4.0 | 4.0 | 4.0 |
| Chain Extender | | .25 | | .25 |
| | | stoichiometry | | stoichiometry |
| TENSILE | 1860 | 2590 | 2039 | 3304 |
| STRENGTH (PSI) | | | | |
| ELONGATION AT | 1054 | 929 | 892 | 836 |
| BREAK (%) | | | | |
| STRESS AT 100% | 248 | 200 | 321 | 250 |
| ELONGATION | | | | |
| (PSI) | | | | |

What is claimed is:

1. A polyurethane film comprising a film prepared from an aqueous polyurethane dispersion, the dispersion being prepared from a nonionic polyurethane prepolymer and water, wherein the nonionic polyurethane prepolymer is prepared from a polyisocyanate and a low monol polyether polyol.

2. The polyurethane film according to claim 1 wherein the dispersion is prepared in the presence of a surfactant and in the substantial absence of an organic solvent.

3. The polyurethane film according to claim 1 wherein the low monol polyether polyol has a molecular weight of at least 3000 Daltons.

4. The polyurethane film according to claim 1 wherein the low monol polyether polyol has a measured unsaturation of less than about 0.025 meq/g.

5. The polyurethane film according to claim 1 wherein the polyisocyanate is an aromatic polyisocyanate selected from the group consisting of MDI, TDI and mixtures thereof.

6. The polyurethane film according to claim 1 wherein the nonionic polyurethane prepolymer has an average practical functionality of less than about 2.1.

7. The polyurethane film according to claim 1 wherein the nonionic polyurethane prepolymer has an isocyanate content of from about 1 to about 9 weight percent.

8. A glove prepared from the film of claim 1.

9. A process for preparing an aqueous polyurethane dispersion comprising
preparing a nonionic polyurethane prepolymer from a polyisocyanate and a low monol polyol; and
admixing the nonionic polyurethane prepolymer with water.

10. The process according to claim 9 wherein the dispersion is prepared in the presence of a surfactant and in the substantial absence of an organic solvent.

11. The process according to claim 9 wherein the low monol polyether polyol has a molecular weight of at least 3000 Daltons.

12. The process according to claim 9 wherein the low monol polyether polyol has a measured unsaturation of less than about 0.025 meq/g.

13. The process according to claim 9 wherein the polyisocyanate is an aromatic polyisocyanate selected from the group consisting of MDI, TI)I and mixtures thereof.

14. An aqueous polyurethane dispersion prepared according to the process of claim 9.

15. The aqueous polyurethane dispersion according to claim 14, wherein the dispersion has a particle size of from 0.9 microns to 0.05 microns.

16. The aqueous polyurethane dispersion according to claim 14, wherein the dispersion has a solids content of from 5 to 60 weight percent.
